(19) United States
(12) Patent Application Publication
(10) Pub. No.: US 2004/0051388 A1
(43) Pub. Date: Mar. 18, 2004

(54) Power tool with replaceable power supply cartridge

(76) Inventor: Chien-Kuo Lin, Chang-Hua Hsien (TW)

Correspondence Address: BAKER BOTTS LLP, C/O INTELLECTUAL PROPERTY DEPARTMENT, THE WARNER, SUITE 1300, 1299 PENNSYLVANIA AVE, NW, WASHINGTON, DC, 20004-2400, US

(21) Appl. No.: 10/281,975

(22) Filed: Oct. 29, 2002

(30) Foreign Application Priority Data
Aug. 30, 2002 (TW) 091213672

(51) Int. Cl. H02J 1/00; H02J 3/00

(52) U.S. Cl. 307/80

(57) ABSTRACT

A power tool includes a tool housing provided with a set of first electrical contacts, an electric drive motor mounted in the tool housing and coupled electrically to the first electrical contacts, and a driver unit mounted in the tool housing and coupled to and driven rotatably by the electric drive motor. A power supply cartridge includes a casing connected removably to the tool housing, a set of second electrical contacts to connect electrically with the first electrical contacts when the casing is connected to the tool housing, and a power converter disposed in the casing and coupled electrically to the second electrical contacts. A power supply cable has a first end connected to the power supply cartridge to connect electrically with the power converter, and a second end adapted to be connected to an external power source.

### CROSS-REFERENCE TO RELATED APPLICATION

This application claims priority of Taiwanese application no. 091213672, filed on Aug. 30, 2002.

### BACKGROUND OF THE INVENTION

1. Field of the Invention

The invention relates to a power tool with a replaceable power supply cartridge, the power tool being operable in either a cordless mode using a self-contained rechargeable battery or a corded mode using a conventional AC or DC power source.

2. Description of the Related Art

Power tools that function in a cordless mode, i.e., powered using a rechargeable battery cartridge, are well known. Cordless power tools have the advantage of not being constrained by electrical cords, which makes them easy to carry and safe to use. However, the lack of a connection to a power source is also the main disadvantage of cordless power tools. Due to the limited storage capacity of batteries, frequent recharging is needed.

To ensure uninterrupted use of the power tool, a corded counterpart can be employed. The main drawback of corded power tools, however, is that the range of movement is limited by the cord length. Further, corded power tools are useless in areas where a conventional AC power source is not available. As a result, both corded and cordless power tools have advantages and disadvantages that cannot be compensated in both aspects.

Dual-mode power tools are also available in the market and can be operated in either the cordless battery mode or the corded AC mode as needed. The dual-mode power tool includes a switch to select between the AC and DC modes. With the availability of such power tools, users can avail of the conveniences of both corded and cordless power tools.

However, the prior art design of a dual-mode power tool is constrained by the cost and complexity of circuit design. Particularly, AC/DC motors used in the prior art design are expensive in comparison with DC- or AC-only motors. Further, due to its inherent duality, the circuit design is relatively complicated.

### SUMMARY OF THE INVENTION

Therefore, the object of the present invention is to provide a power tool with a replaceable power supply cartridge that is convenient to use and that can be fabricated at a relatively low cost.

According to the present invention, a power tool comprises:

a tool housing provided with a set of first electrical contacts;

an electric drive motor mounted in the tool housing and coupled electrically to the first electrical contacts;

a driver unit mounted in the tool housing and coupled to and driven rotatably by the electric drive motor;

a power supply cartridge including a casing connected removably to the tool housing, a set of second electrical contacts to connect electrically with the first electrical contacts when the casing is connected to the tool housing, and a power converter disposed in the casing and coupled electrically to the second electrical contacts; and

a power supply cable having a first end connected to the power supply cartridge to connect electrically with the power converter, and a second end adapted to be connected to an external power source.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of the first preferred embodiment of a power tool with a replaceable power supply cartridge according to the present invention;

FIG. 2 is a schematic circuit block diagram of the first preferred embodiment;

FIG. 3 is a schematic circuit block diagram of the second preferred embodiment of a power tool according to the present invention;

FIG. 4 is a schematic circuit block diagram of the third preferred embodiment of a power tool according to the present invention;

FIG. 5 is a schematic circuit block diagram of the fourth preferred embodiment of a power tool according to the present invention; and

FIG. 6 is a perspective view of a replaceable power supply cartridge of the fifth preferred embodiment of a power tool according to the present invention.

### DETAILED DESCRIPTION OF THE PREFERRED EMBODIMENTS

Before the present invention is described in greater detail, it should be noted that like elements are denoted by the same reference numerals throughout the disclosure.

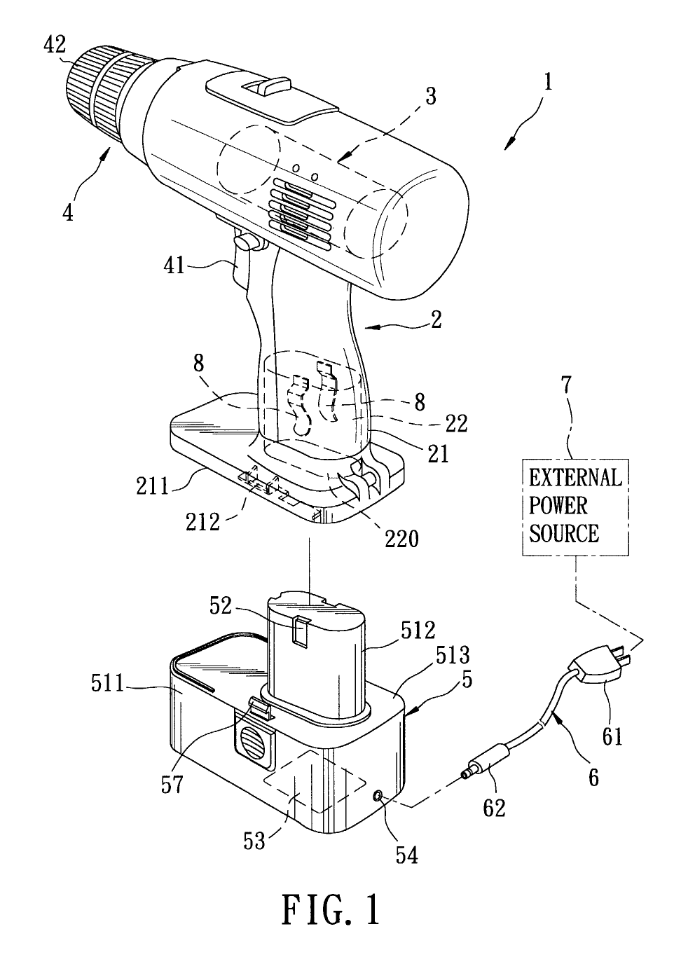

Referring to FIG. 1, the first preferred embodiment of a power tool 1 according to the present invention is shown to comprise a tool housing 2, an electric drive motor 3, a driver unit 4, a power supply cartridge 5, and a power supply cable 6.

The tool housing 2 has a bottom portion 21, in the form of a handle. The bottom portion 21 defines therein a cavity 22, which has an open end 220 that faces downwardly. Located within the cavity is a set of first electrical contacts 8. Adjacent to the open end 220, the bottom portion 21 is formed with an outwardly extending skirt 211. The bottom side of the skirt 211 is provided with fastening grooves 212.

The electric drive motor 3 is mounted in the tool housing 2 and is coupled electrically to the first electrical contacts 8. In this embodiment, the electric drive motor 3 is a direct current (DC) motor.

The driver unit 4 is mounted in the tool housing 2 and is coupled to and is driven by the electric drive motor 3. In this embodiment, the driver unit 4 includes a trigger mechanism 41 for controlling actuation of the electric drive motor 3 in a conventional manner, and a driver element 42, in the form of a conventional chuck for screw driving, driven by the electric drive motor 3 in a known manner.

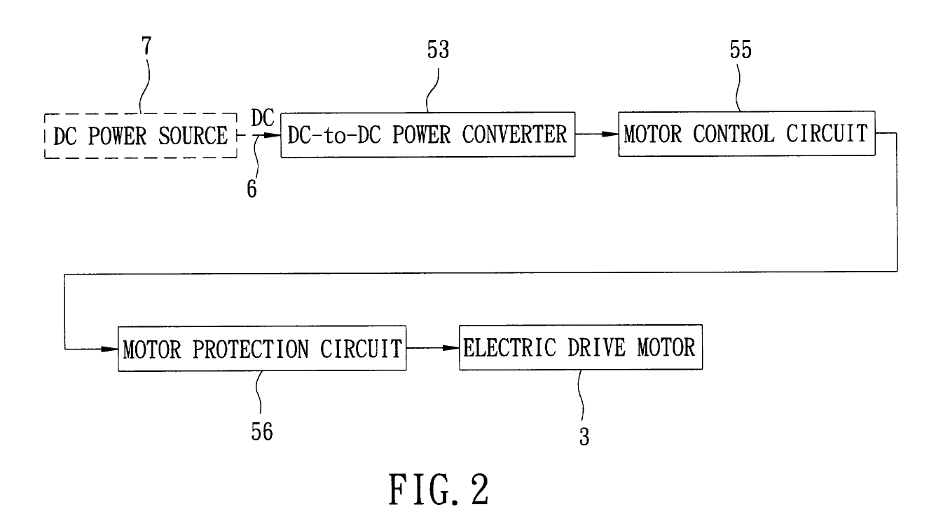

With further reference to FIG. 2, the power supply cartridge 5 includes a casing 511 to be connected removably to the tool housing 2, a set of second electrical contacts 52, a power converter 53, a motor control circuit 55, and a motor protection circuit 56. The casing 511 includes a base portion 513, and an insert portion 512 that protrudes integrally and upwardly-from the base portion 513 and that is inserted removably into the insert cavity 22 through the open end 220. The base portion 513 is provided with a pair of hook fasteners 57 that are associated operably with the fastening grooves 212 in the tool housing 2. The fastening grooves 212 and the hook fasteners 57 constitute a releasable fastener unit for-fastening releasably the casing 511 on the tool housing 2.

The second electrical contacts 52 are mounted on the insert portion 512 and are configured to connect electrically with the first electrical contacts 8 when the casing 511 is connected to the tool housing 2. In this embodiment, the power converter 53, the motor control circuit 55, and the motor protection circuit 56 are connected in series and are disposed in the casing 511. The power converter 53 is coupled electrically to the second electrical contacts 52 through the motor control circuit 55 and the motor protection circuit 56. In the case that the motor control circuit 55 and the motor protection circuit 56 are disposed in the tool housing 2 instead of the casing 511, the power converter 53 can be connected directly to the second electrical contacts 52. The power converter 53 of this embodiment is a DC-to-DC power converter. Since the structures of the motor control circuit 55 and the motor protection circuit 56 are known to those skilled in the art, a detailed description of the same will be dispensed with herein for the sake of brevity. In this embodiment, a socket 54 is mounted on the base portion 513 and is connected electrically to the power converter 53.

Therefore, when the casing 511 is connected to the tool housing 2, the second electrical contacts 52 will establish electrical connection with the first electrical contacts 8, thereby permitting electrical coupling between the power converter 53 and the electric drive motor 3.

In this embodiment, the power supply cable 6 has a first end provided with a connector 62 to connect removably with the socket 54 of the power supply cartridge 5, thereby connecting the power supply cable 6 to the power converter 53. The power supply cable 6 further has a second end provided with a plug 61 to connect removably with an external power source 7, in the form of a DC power source, such as a lithium battery. When the power supply cable 6 connects the power supply cartridge 5 to the external power source 7, electric power for operating the electric drive motor 5 can be supplied accordingly.

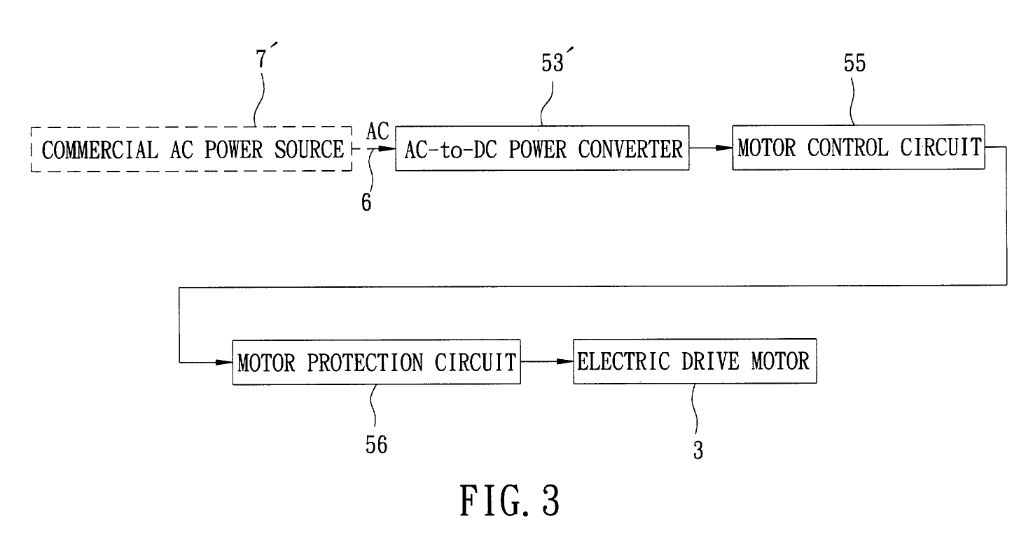

FIG. 3 illustrates the second preferred embodiment of a power tool according to the present invention. Unlike the previous embodiment, the power converter 53′ is an AC-to-DC power converter, and the external power source 7′ is a commercial AC power source.

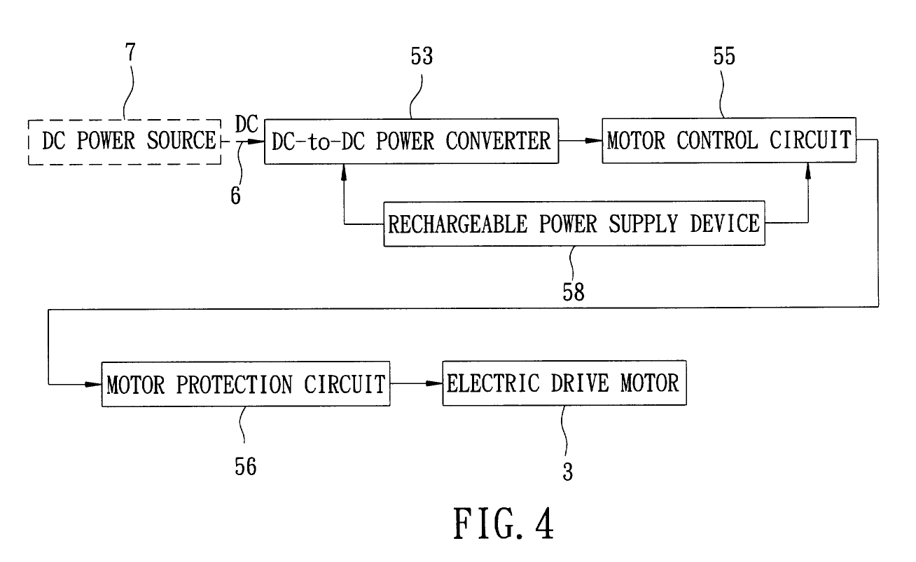

FIG. 4 illustrates the third preferred embodiment of a power tool according to the present invention. When compared to the first preferred embodiment, the power supply cartridge further includes a rechargeable power supply device 58 coupled electrically to the power converter 53 and to the second electrical contacts (not shown) through the motor control circuit 55 and the motor protection circuit 56. In the case that the motor control circuit 55 and the motor protection circuit 56 are disposed in the tool housing instead of the power supply cartridge, the rechargeable power supply device 58 can be connected directly to the second electrical contacts. The rechargeable power supply device 58 is a known device that includes a rechargeable battery and associated charging circuit, and is disposed within the casing 511. During operation, when connected to the external power source 7, concurrent with providing DC power to the electric drive motor 3, the power converter 53 also supplies charging power for charging the rechargeable power supply device 58. Thereafter, when the power supply cartridge is disconnected from the external power source 7, the rechargeable power supply device 58 can operate to supply DC power to the electric drive motor 3.

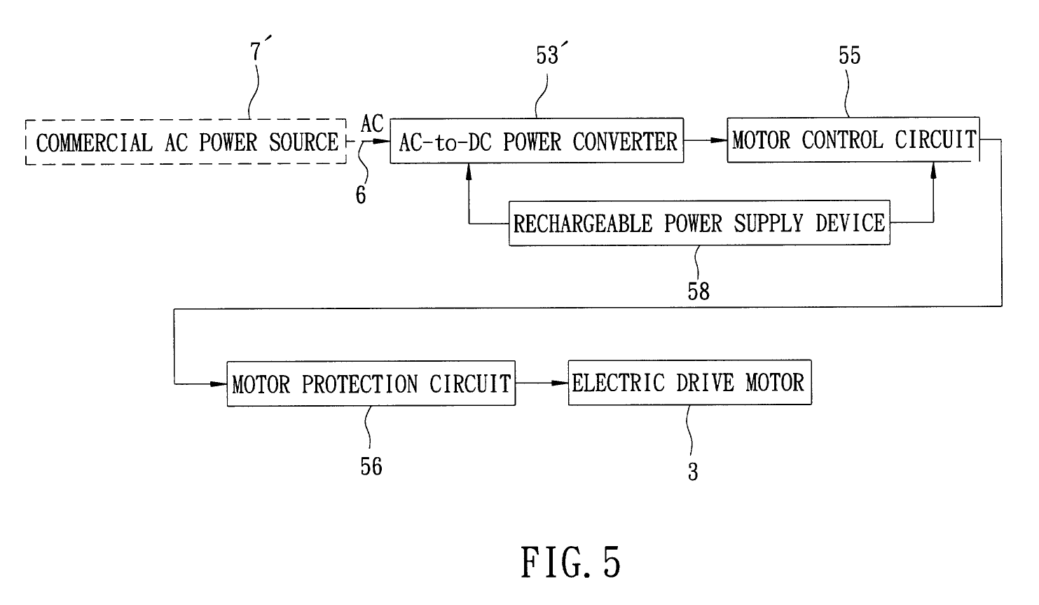

FIG. 5 illustrates the fourth preferred embodiment of a power tool according to the present invention. When compared to the second preferred embodiment, the power supply cartridge further includes a rechargeable power supply device 58 coupled electrically to the power converter 53′ and to the second electrical contacts (not shown) through the motor control circuit 55 and the motor protection circuit 56. Since the rechargeable power supply device 58 operates in a manner similar to that in the third preferred embodiment, a detailed description of the same will be dispensed with herein for the sake of brevity.

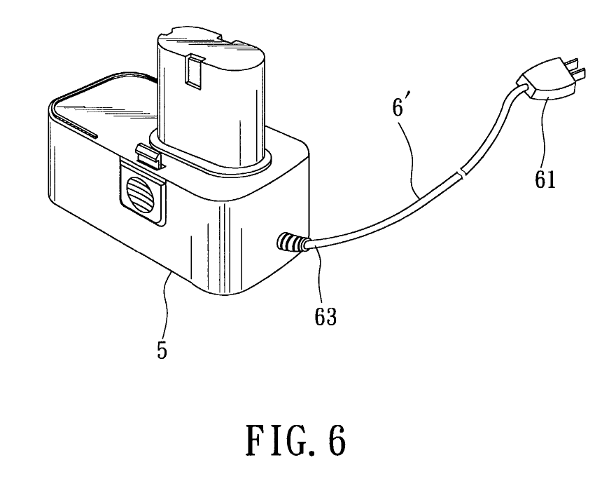

Referring to FIG. 6, in the sixth preferred embodiment of a power tool according to this invention, the first end 63 of the power supply cable 6′ is connected fixedly to the power supply cartridge 5. The second end of the power supply cable 6″ is provided with the plug 61 to connect removably with the external power source (not shown).

The power tool according to this invention is connectable to either a commercial AC power source or a DC power source. Moreover, the power tool can also be powered by a rechargeable power supply device of the power supply cartridge that can be charged by the commercial AC power source or the DC power source. Thus, operation of the power tool in either a cordless mode using a self-contained rechargeable battery or a corded mode using a conventional AC power source or DC power source is possible in the power tool of this invention by merely replacing the power supply cartridge that is connected to the tool housing. The replaceable power supply cartridge also simplifies the implementation of circuit designs. It is also noted that the power tool of this invention employs a DC motor, which is much cheaper than conventional AC/DC motors.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

We claim:

1. A power tool comprising;
a tool housing provided with a set of first electrical contacts;
an electric drive motor mounted in said tool housing and coupled electrically to said first electrical contacts;
a driver unit mounted in said tool housing and coupled to and driven rotatably by said electric drive motor;
a power supply cartridge including a casing connected removably to said tool housing, a set of second electrical contacts to connect electrically with said first electrical contacts when said casing is connected to said tool housing, and a power converter disposed in said casing and coupled electrically to said second electrical contacts; and
a power supply cable having a first end connected to said power supply cartridge to connect electrically with said power converter, and a second end adapted to be connected to an external power source.

2. The power tool as claimed in claim 1, wherein said tool housing is formed with an insert cavity having an open end, said first electrical contacts being mounted in said insert cavity, said casing being formed with an insert portion that is inserted removably into said insert cavity through said open end, said second electrical contacts being mounted on said insert portion.

3. The power tool as claimed in claim 2, wherein said tool housing has a bottom portion formed with said insert cavity, said open end of said insert cavity facing downwardly.

4. The power tool as claimed in claim 1, further comprising a releasable fastener unit provided on said tool housing and said casing to fasten releasably said casing on said tool housing.

5. The power tool as claimed in claim 1, wherein said power converter is a direct current-to-direct current power converter, said electric drive motor is a direct current motor, and the external power source is a direct current power source.

6. The power tool as claimed in claim 1, wherein said power converter is an alternating current-to-direct current power converter, said electric drive motor is a direct current motor, and the external power source is a commercial alternating current power source.

7. The power tool as claimed in claim 1, wherein said power supply cartridge further includes a rechargeable power supply device coupled electrically to said power converter and said second electrical contacts.

8. The power tool as claimed in claim 7, wherein said power converter is a direct current-to-direct current power converter, said electric drive motor is a direct current motor, and the external power source is a direct current power source.

9. The power tool as claimed in claim 7, wherein said power converter is an alternating current-to-direct current power converter, said electric drive motor is a direct current motor, and the external power source is a commercial alternating current power source.

10. The power tool as claimed in claim 1, wherein said first end of said power supply cable is provided with a connector to connect removably with said power supply cartridge, and said second end of said power supply cable is provided with a plug to connect removably with the external power source.

11. The power tool as claimed in claim 1, wherein said first end of said power supply cable is connected fixedly to said power supply cartridge, and said second end of said power supply cable is provided with a plug to connect removably with the external power source.
